(19) United States
(12) Patent Application Publication
(10) Pub. No.: US 2021/0016234 A1
(43) Pub. Date: Jan. 21, 2021

(54) NANOBUBBLE MANUFACTURING METHOD AND SYSTEM THEREOF, AND A FERTILIZER MANUFACTURING METHOD AND SYSTEM THEREOF

(71) Applicant: Bo-Han LIN, Taipei City (TW)

(72) Inventor: Bo-Han LIN, Taipei City (TW)

(21) Appl. No.: 16/656,681

(22) Filed: Oct. 18, 2019

(30) Foreign Application Priority Data
Jul. 19, 2019 (TW) 108125562

(51) Int. Cl. B01F 3/04; B01F 11/02; C02F 1/68; C05G 3/00; C05D 7/00; C05D 9/00

(52) U.S. Cl. CPC B01F 3/04106; B01F 11/02; C02F 1/68; C05G 3/0076; B01F 2215/0055; C05D 9/00; B01F 2003/04879; B01F 2003/04921; B01F 2003/04893; C05D 7/00

(57) ABSTRACT

A nanobubble manufacturing system comprising: a gas supply unit, supplying gas; a mixing device, mixing the gas with liquid into a first solution; and an ultrasonic oscillator, vibrating the first solution to produce a second solution having nanobubbles.

### FIELD

The present invention relates to a nanobubble manufacturing method, particularly relates to a nanobubble manufacturing method for agriculture application.

### BACKGROUND OF THE DESCRIPTION

Nanobubbles refer to tiny bubbles in liquid, generally refer to size less than 500 nm bubbles in water, also refer to nano-bubbles or nano bubbles. The nanobubbles have several physical properties: first, because the surface charges of the nanobubbles are negatively charged, they can be kept stable in water for a long time, and do not rise to the surface and burst as quickly as ordinary bubbles. It can exist in water for a long time. In addition, internal pressure of nanobubbles in the liquid is above its surrounding environment, which accelerates the dissolution speed of the gas into the liquid, thus gas molecules continuously enter and exit nanobubbles. Therefore, nanobubbles can be used as good carrier to transport biologically required gases such as oxygen or carbon dioxide. However, due to the external pressure and surface tension, nanobubbles would gradually shrink over time, the number and total volume of nanobubbles in water will gradually decrease. It is necessary to control size of nanobubbles and produce relatively smaller size of the nanobubbles, for example less than 100 nm, to substantially increase number density and total surface area of nanobubbles, such that allowing the nanobubbles to exist in the liquid for longer time.

### SUMMARY OF THE INVENTION

In view of the purpose of the present invention, the present invention provides a nanobubble manufacturing system comprising: a gas supply unit, supplying gas; a mixing device, mixing the gas with liquid into a first solution; and an ultrasonic oscillator, vibrating the first solution to produce a second solution having nanobubbles. It is possible to produce nanobubbles having a smaller size, so that the bubbles can be present in the liquid for a longer period of time.

### BRIEF DESCRIPTION OF DRAWINGS

The embodiments of the present application are shown by way of example and not limitation in the accompanying drawings, like numerals being used for like elements.

FIG. 1 illustrates a block diagram of a nanobubble manufacturing system according to an embodiment of the present invention.

FIG. 2 illustrates a block diagram of a nanobubble manufacturing system may further detect nanobubbles according to an embodiment of the present invention.

FIG. 3 illustrates a schematic diagram of distribution of nanobubble size (diameter) according to an embodiment of the present invention.

FIG. 4 illustrates the average size of the nanobubbles according to FIG. 3.

FIG. 5 illustrates a nanobubble manufacturing method according to an embodiment of the present invention.

FIG. 6 illustrates a nanobubble detecting method according to an embodiment of the present invention.

### DETAILED DESCRIPTION

The principles of the present invention will be described below with reference to a number of illustrative embodiments shown in the accompanying drawings. It should be understood that these embodiments are described merely to enable those persons skilled in the art to better understand the present invention, and are not intended to limit the scope of the present invention in any way.

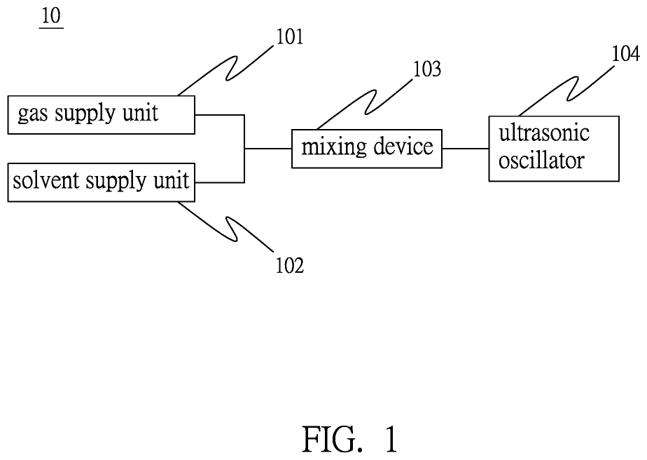

Please refer to FIG. 1, which is a block diagram of a nanobubble manufacturing system according to an embodiment of the present invention. The nanobubble manufacturing system 10 includes a gas supply unit 101, a solvent supply unit 102, a mixing device 103, and an ultrasonic oscillator 104. In one embodiment, the solvent supply unit 102 may provide clean water or deionized water (DI water) as solvent, in another embodiment, in the case of using water that may contain impurities as a solvent, such as tap water or boiled tap water, the solvent supply unit 102 may further comprise a 0.1 um filter (not shown) to filter impurities in the solvent to provide a clean solvent.

In one embodiment, the gas supply unit 101 may supply a desired gas such as carbon dioxide, nitrogen, or the like, but the present invention is not limited thereto. In one embodiment, the gas supply unit 101 mixes the solvent supplied from the solvent supply unit 102 with the gas supplied from the gas supply unit 101 through the mixing device 103 to form a first solution, in another embodiment, the solvent supply unit 102 may also be a container directly filled with a solvent, and the gas supply unit 101 may directly supply the gas to the solvent supply unit 102 to be mixed into the first solution. In one embodiment, the gas supply unit 101 mixes the gas into the solvent supplied from the solvent supply unit 102 under a condition of 6 PSI (pounds per square inch), 20 minutes.

Next, the first solution is vibrated by the ultrasonic oscillator 104 to produce a second solution having nanobubbles. In one embodiment, the ultrasonic oscillator 104 vibrates the first solution at 40 kHz for 10˜30 minutes to produce a second solution having nanobubbles.

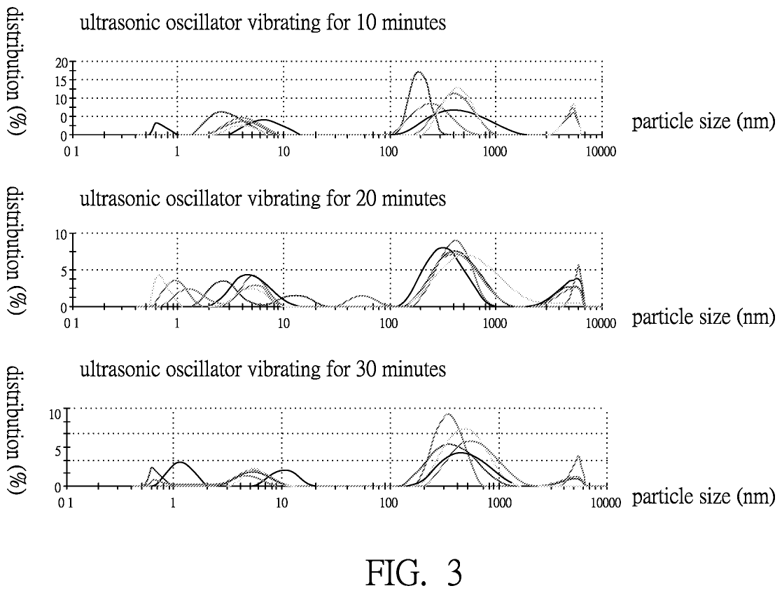

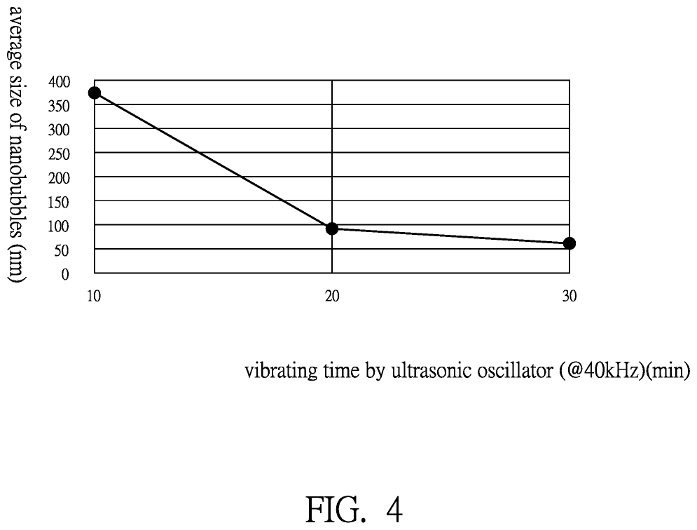

Please refer to FIG. 3, illustrates a schematic diagram of distribution of nanobubbles size (diameter), wherein nitrogen gas was injected into the deionized water for 6 PSI, 20 minutes by the gas supply unit 101, the deionized water after nitrogen injection was vibrated by the ultrasonic oscillator 104 at 40 kHz for 10 minutes, 20 minutes, or 30 minutes, and the size (diameter) of the nanobubbles in the second solution was measured using an zetapotential analyzer (Malvern Zetasizer Nano ZS90). Please refer to FIG. 4, which illustrates the average size of the nanobubbles according to FIG. 3. It can be clearly seen that an average size of the nanobubbles is 400 nm or less in the case of vibrating for 10 minutes by the ultrasonic oscillator 104, the average size of the nanobubbles can be reduced to 100 nm or less in the case of vibrating for 20 minutes by the ultrasonic oscillator 104, the average size of nanobubbles can be further reduced to 70 nm or less in the case of vibrating for 30 minutes by the ultrasonic oscillator 104, and the size of nanobubbles may even be less than 30 nm. Therefore, it can be seen that the vibration by the ultrasonic oscillator 104 for more than 10 minutes has produced nanometer-level bubbles, vibrating for 20 minutes may produce nanobubbles with smaller average size, and after vibrating for 30 minutes or more, nanobubbles with an average size closer to the nanometer-level will be realized.

However, in the process of generating the nanobubbles described above, if impurities are incorporated, there is a possibility that the measured particle diameter may be the particle diameter of the impurities. Therefore, in one embodiment, a detecting process may be added during the process of manufacturing the nanobubbles to confirm that the manufactured nanobubbles meet the required conditions, such that the manufactured nanobubbles meet the required standard, and it is not misunderstood that the particle size of the impurity as the particle size of the nanobubbles.

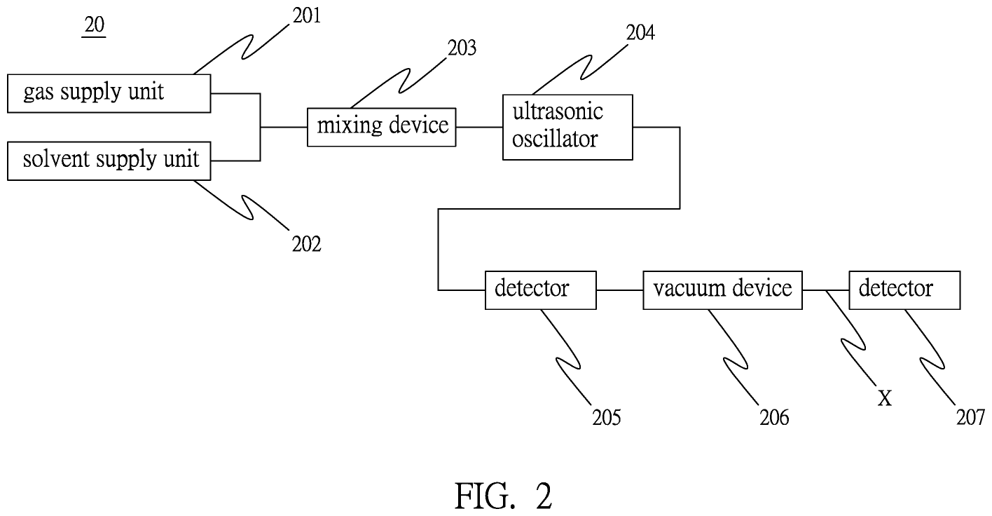

Please refer to FIG. 2, a block diagram of a nanobubble manufacturing system according to an embodiment of the present invention. The same part as in the previous embodiment will not be repeated. The nanobubble manufacturing system 20 further includes a detector 205, a vacuum device 206 and a detector 207. The detector 205 detects the number of particles in the second solution generated after the vibration of the ultrasonic oscillator 204, for example, in the case of using deionized water as a solvent, in one embodiment, the detector 205 such as Malvern Zetasizer Nano series detects the number Q1 of particles in the second solution for at least a portion or all of the second solution, then, the gas is removed from the second solution into sample X to be detected by the vacuum device 206, the number Q2 of particles of the sample X to be detected is detected by another detector 207. Since the vacuum device 206 only removes the gas in the second solution instead of the impurities, it can be determined whether the number Q1 of the originally detected particles is the number of nanobubbles by the number Q1 and Q2. Specifically, if Q2=Q1>0, it means that there are residual particles, that is, the number Q1 of particles in the second solution is the number of particles of impurities, not the number of particles of nanobubbles. If Q1>Q2>0, it means that one part of the number Q1 of particles in the second solution is the number of particles of the nanobubble, and one part of which is the number of particles of the impurities. If Q2=0, it means that the number Q1 of particles in the second solution is all the number of particles of the nanobubbles. In one embodiment, whether the second solution meets the requirements can be determined based on the value of Q2. For example, when Q2/Q1 (impurity ratio) is less than 50%, 60%, 70%, 80% or 90%, it means the manufactured nanobubbles of the second solution reach a certain proportion or quantity, and not most or all of them are impurities. In one embodiment, Q1-Q2 as effective nanobubble number is used as a criterion to determine whether the second solution includes the number of required nanobubbles. In one embodiment, the detector 205 and the detector 207 may be the same detector. In another implementation, the detector 205 and the detector 207 may also be independent detectors, and the invention is not limited thereto.

In one embodiment, the nanobubble manufacturing system of the previous embodiment is used as a fertilizer manufacturing device or a portion of a fertilizer manufacturing device. In one embodiment, at least one of oxygen, carbon dioxide, and nitrogen is added to the solvent as a fertilizer for agriculture by using a nanobubble manufacturing system, i.e., utilizing the characteristics that the nanobubbles can exist in the solvent for a long time, at least one of oxygen, carbon dioxide, and nitrogen can exist in the solvent for a longer period of time, such that gas such as carbon dioxide can be supplied as plant nutrients for a longer period of time when the fertilizer is added to the soil.

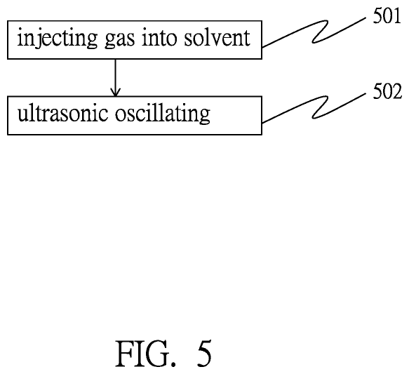

Next, referring to FIG. 5, a nanobubble manufacturing method according to an embodiment of the present invention, which includes: injecting gas into solvent 501 and ultrasonic oscillating 502. In one embodiment, clean water or deionized water (DI water) may be provided as a solvent, in another embodiment, in the case of using water that may contain impurities as a solvent, such as tap water or boiled tap water, it may further comprise a 0.1 um filter (not shown) to filter the impurities in the solvent, to provides a clean solvent.

In one embodiment, for example, oxygen, carbon dioxide, nitrogen, or the like may be supplied as the required gas, but the present invention is not limited thereto. In one embodiment, the solvent and gas are mixed into a first solution through a mixing device. In another embodiment, the gas may be directly supplied to a solvent-containing container and mixed into a first solution. In one embodiment, gas is supplied to be mixed into a solvent to form a first solution. In one embodiment, the gas is mixed to the supplied solvent under a condition of 6 PSI (pounds per square inch), 20 minutes.

Next, the first solution is vibrated by the ultrasonic oscillator to produce a second solution having nanobubbles. In one embodiment, the ultrasonic oscillator vibrates the first solution at 40 kHz for 10˜30 minutes to produce a second solution having nanobubbles. The relationship between the vibration conditions and the average size of the nanobubbles has been described in the previous embodiment and will not be repeated.

However, in the process of generating the nanobubbles described above, if impurities are incorporated, there is a possibility that the measured particle diameter may be the particle diameter of the impurities. Therefore, in one embodiment, a detecting process may be added during the process of manufacturing the nanobubbles to confirm that the manufactured nanobubbles meet the required conditions, to make the manufactured nanobubbles meet the required standard, and it is not misunderstood the particle size of the impurity as the particle size of the nanobubbles.

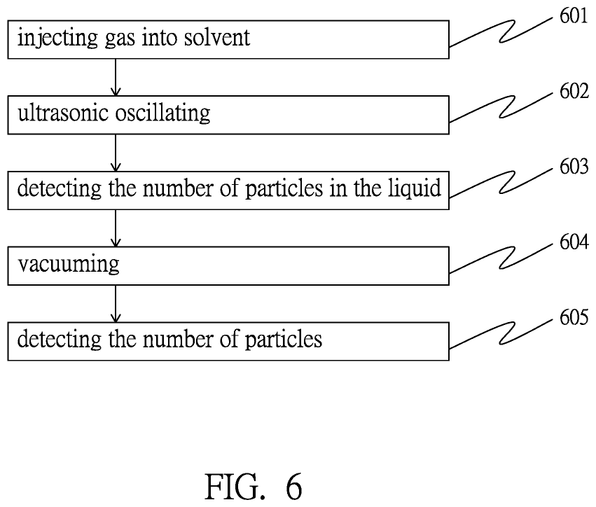

Next, please refer to FIG. 6, which is a nanobubble detecting method according to an embodiment of the present invention. The same part as in the previous embodiment will not be repeated. The nanobubble manufacturing method further includes detecting the number of particles in the liquid 603, vacuuming 604, and detecting the number of particles 605. First, detecting the number of particles in the second solution generated by the ultrasonic oscillator by the detector, for example, in the case of using deionized water as a solvent, the detector such as Malvern Zetasizer Nano series detects the number Q1 of particles in the second solution for at least a portion or all of the second solution, then, the gas is removed from the second solution into sample X to be detected by the vacuum device, the number Q2 of particles of the sample X to be detected is detected by another detector. Since the vacuum device only removes the gas in the second solution instead of the impurities, it can be determined whether the number Q1 of the originally detected particles is the number of nanobubbles by the number of Q1 and Q2. Specifically, if Q2=Q1>0, it means that there are residual particles, that is, the number Q1 of particles in the second solution is the number of particles of impurities, not the number of particles of nanobubbles. If Q1>Q2>0, it means that one part of the number Q1 of particles in the second solution is the number of particles of the nanobubble, and one part of which is the number of particles of the impurities. If Q2=0, it means that the number Q1 of particles in the second solution is all the number of particles of the nanobubbles. In one embodiment, whether the second solution meets the requirements can be determined based on the value of Q2. For example, when Q2/Q1 (impurity ratio) is less than 50%, 60%, 70%, 80% or 90%, it means the manufactured nanobubbles of the second solution reach a certain proportion or quantity, and not most or all of them are impurities. In one embodiment, Q1-Q2 as effective nanobubble number is used as a criterion to determine whether the second solution includes the number of required nanobubbles. In one embodiment, the another detector may be directly implemented by using the detector, and the present invention is not limited thereto.

In one embodiment, the nanobubble manufacturing method of the previous embodiment is used as a fertilizer manufacturing method or a portion of a fertilizer manufacturing method. In one embodiment, at least one of oxygen, carbon dioxide, and nitrogen is added to the solvent as a fertilizer for agriculture by using a nanobubble manufacturing method, i.e., utilizing the characteristics that the nanobubbles can exist in the solvent for a long time, at least one of oxygen, carbon dioxide, and nitrogen can exist in the solvent for a longer period of time. Thus after the fertilizer is added to the soil, gas such as carbon dioxide can be supplied as plant nutrients for a longer period of time.

Now, examples related to the present invention will be added below. Note that the present invention is not limited to the following examples.

Example 1 may include a nanobubble manufacturing system, comprising: a gas supply unit, supplying gas; a mixing device, mixing the gas with liquid into a first solution; and an ultrasonic oscillator, vibrating the first solution to produce a second solution having nanobubbles.

Example 2 may include the nanobubble manufacturing system of example 1, wherein the gas is at least one of nitrogen, oxygen, and carbon dioxide, and the liquid is water

Example 3 may include the nanobubble manufacturing system of example 1, wherein the gas supply unit mixes the gas into the liquid through the mixing device under a condition of 6 PSI, 20 minutes.

Example 4 may include the nanobubble manufacturing system of example 1, wherein the ultrasonic oscillator vibrates the first solution at 40 kHz for 10 to 30 minutes to generate nanobubbles.

Example 5 may include the nanobubble manufacturing system of example 1, wherein the nanobubble manufacturing system further comprising: a detector, detecting the number of particles in the second solution; and a vacuum device, removing the gas from the second solution into a sample to be detected; wherein, the number of residual particles of the sample to be detected is detected by the detector or another detector.

Example 6 may include a fertilizer manufacturing system using the nanobubble manufacturing system according to any one of claims 1 to 5.

Example 7 may include a nanobubble manufacturing method, comprising: injecting gas into liquid to become a first solution; vibrating the first solution by ultrasonic waves to produce a second solution having nanobubbles.

Example 8 may include the nanobubble manufacturing method of example 7, wherein the gas is at least one of nitrogen, oxygen, and carbon dioxide, and the liquid is water; wherein, injecting the gas into the liquid to become the first solution under a condition of 6 PSI, 20 minutes; wherein, vibrating the first solution by ultrasonic waves at 40 kHz for 10 to 30 minutes to generate nanobubbles.

Example 9 may include the nanobubble manufacturing method of example 7, wherein the nanobubble manufacturing method further comprising: detecting the number of particles in the second solution; removing the gas from the second solution into a sample to be detected; and detecting the number of residual particles of the sample to be detected by the detector or another detector.

Example 10 may include a fertilizer manufacturing method comprising using the nanobubble manufacturing method according to any one of claims 7 to

The above are merely alternative embodiments of the present invention and are not intended to limit the invention. For those persons skilled in the art, the invention may have various changes and modifications. Any modification, equivalent replacement, or improvement made within the spirit and principle of the present invention shall fall within the protection scope of the present invention.

What is claimed is:

1. A nanobubble manufacturing system, comprising:
a gas supply unit, supplying gas;
a mixing device, mixing the gas with liquid into a first solution; and
an ultrasonic oscillator, vibrating the first solution to produce a second solution having nanobubbles.

2. The nanobubble manufacturing system according to claim 1, wherein the gas is at least one of nitrogen, oxygen, and carbon dioxide, and the liquid is water.

3. The nanobubble manufacturing system according to claim 1, wherein the gas supply unit mixes the gas into the liquid through the mixing device under a condition of 6 PSI, 20 minutes.

4. The nanobubble manufacturing system according to claim 1, wherein the ultrasonic oscillator vibrates the first solution at 40 kHz for 10 to 30 minutes to generate nanobubbles.

5. The nanobubble manufacturing system according to claim 1, wherein the nanobubble manufacturing system further comprising:
a detector, detecting the number of particles in the second solution; and
a vacuum device, removing the gas from the second solution into a sample to be detected;
wherein, the number of residual particles of the sample to be detected is detected by the detector or another detector.

6. A fertilizer manufacturing system using the nanobubble manufacturing system according to any one of claims 1 to 5.

7. A nanobubble manufacturing method, comprising:
injecting gas into liquid to become a first solution;
vibrating the first solution by ultrasonic waves to produce a second solution having nanobubbles.

8. The nanobubble manufacturing method according to claim 7, wherein the gas is at least one of nitrogen, oxygen, and carbon dioxide, and the liquid is water;
wherein, injecting the gas into the liquid to become the first solution under a condition of 6 PSI, 20 minutes;
wherein, vibrating the first solution by ultrasonic waves at 40 kHz for 10 to 30 minutes to generate nanobubbles.

9. The nanobubble manufacturing method according to claim 7, wherein the nanobubble manufacturing method further comprising:
detecting the number of particles in the second solution;
removing the gas from the second solution into a sample to be detected; and
detecting the number of residual particles of the sample to be detected by the detector or another detector.

10. A fertilizer manufacturing method comprising using the nanobubble manufacturing method according to any one of claims 7 to 9.
